(19) United States
(12) Patent Application Publication
(10) Pub. No.: US 2017/0122363 A1
(43) Pub. Date: May 4, 2017

(54) CABLE SPONGE DAMPER FOR MANUAL TRANSMISSION AND STRUCTURE FOR FASTENING THE SAME

(71) Applicants: Hyundai Motor Company, Seoul (KR); Kia Motors Corporation, Seoul (KR)

(72) Inventors: Yong-Ik Kim, Hanam (KR); Ja-Yong Koo, Hwaseong (KR); Eun-Sik Kim, Gwangmyeong (KR)

(21) Appl. No.: 15/070,598

(22) Filed: Mar. 15, 2016

(30) Foreign Application Priority Data
Nov. 2, 2015 (KR) 10-2015-0153226

(51) Int. Cl. F16C 1/10

(52) U.S. Cl. CPC F16C 1/108

(57) ABSTRACT

A cable sponge damper for a manual transmission and a structure for fastening the same are provided. The cable sponge damper for a manual transmission is configured as a single constituent element, attenuates NVH of a shift cable and a selection cable. Accordingly, the configuration solves problems which are caused by a configuration in which cable sponge dampers in the related art for a manual transmission are formed by bonding and coupling sponge pads which are provided as separate constituent elements at a shift cable side and a selection cable side, respectively.

### CROSS-REFERENCE TO RELATED APPLICATIONS

This application claims priority under 35 U.S.C. §119 to Korean Patent Application No. 10-2015-0153226, filed on Nov. 2, 2015, in the Korean Intellectual Property Office, the disclosure of which is incorporated herein by reference in its entirety.

### BACKGROUND

### 1. Field of the Invention

The present invention relates to a cable sponge damper for a manual transmission and a structure for fastening the same, and more particularly, to a technology in which a cable sponge damper for a manual transmission, which is configured as a single constituent element, attenuates noise, vibration, and harshness (NVH) of a shift cable and a selection cable to solve problems which are caused by a configuration in which cable sponge dampers in the related art for a manual transmission are formed by bonding and coupling sponge pads which are provided as separate constituent elements at a shift cable side and a selection cable side, respectively.

### 2. Description of the Related Art

In general, a manual transmission, a type of transmission included in a drive system of a vehicle, is an apparatus that allows a user to manually perform a gear shift operation using a shift lever installed in a driver seat. Therefore, the driver's operation of manipulating the shift lever is transferred to the manual transmission, and accordingly, the manual transmission and the shift lever are connected via a shift cable and a selection cable.

However, noise, vibration, and harshness (NVH) occur at a powertrain (PT) side, particularly, at a transmission (TM) side of a vehicle when the vehicle is being driven, and the NVH is transmitted to the shift lever and interior devices within the vehicle via cables connected with the manual transmission, which may cause discomfort to a driver or an occupant. Therefore, dampers configured to reduce the NVH are applied to the cables for a manual transmission, and as one of the dampers, a sponge damper is applied to the manual transmission cable.

FIGS. 1 to 3 illustrate a perspective view, a top plan view, and a side view of a manual transmission system to which a sponge damper in the related art is applied, and FIG. 4 illustrates a cross section of a portion of the sponge damper in the related art. As illustrated in FIG. 1, the sponge dampers in the related art are configured as a pair of cylindrical sponges having cable penetrating portions formed by piercing the sponges along central axes of the sponges, and applied to a shift cable and a selection cable, respectively, thereby reducing the NVH.

In other words, the sponge dampers in the related art, which are configured as thick sponges, are attached, by an adhesive, to particular positions of the shift cable and the selection cable, and the sponge dampers maximally absorb, reduce and inhibit the transmission NVH transmitted from the manual transmission, and allows a part of the NVH to be transmitted to the shift lever.

However, the sponge damper in the related art, which is configured as described above, requires a substantial large diameter to improve NVH attenuation performance, but as illustrated in FIG. 2, as the diameters of the pair of sponge dampers increase, a space between the pair of sponge dampers may increase when a local contact occurs in view of a layout. As a result, operation characteristics of the shift lever may be degraded, and the NVH attenuation performance may also deteriorate.

In addition, since the sponge dampers in the related art are configured as the pair of separated constituent elements, costs increase during a process of applying the sponge dampers to a shift cable side and a selection cable side, respectively. In other words, since the pair of separately configured constituent elements are to be manufactured separately, and the pair of constituent elements require separate coupling to the shift cable and the selection cable, respectively, the processes are more complex, and manufacturing costs increase.

Further, as illustrated in FIG. 3, when the space between the sponge dampers in the related art is increased due to contact between the sponge dampers and peripheral components, the operating characteristics of the shift lever may be degraded as described above, and it may be impossible to prevent deterioration in NVH attenuation performance, particularly, at an edge portion.

### SUMMARY

The present invention provides a cable sponge damper for a manual transmission and a structure for fastening the same, which are configured as a cable sponge damper for a manual transmission as a single constituent element, and improve NVH attenuation performance by using a sponge damper with a smaller volume compared to the related art to solve problems such as a limitation of a layout, high manufacturing costs, deterioration in NVH attenuation performance, and deterioration in operating characteristics which are caused by a configuration in which cable sponge dampers in the related art for a manual transmission are formed by bonding and coupling sponge pads which are provided as separate constituent elements at a shift cable side and a selection cable side.

An exemplary embodiment of the present invention provides a cable sponge damper for a manual transmission that may include: a body portion configured by a sponge material having a predetermined shape; a shift cable penetrating portion formed by piercing the body portion to extend straight from a front end portion to a rear end portion of the body portion; a selection cable penetrating portion formed by piercing the body portion to extend straight from the front end portion to the rear end portion of the body portion, and disposed in parallel with the shift cable penetrating portion; and an assembling slit portion which extends from the front end portion to the rear end portion along a central axis of the selection cable penetrating portion, and formed by being cut out with a first end of the assembling slit portion abutting the selection cable penetrating portion and a second end of the assembling slit portion abutting an outer surface of the body portion.

In particular, the assembling slit portion may extend from the front end portion and the rear end portion along the central axis of the selection cable penetrating portion and may be formed by being cut out vertically with a first end of the assembling slit portion abutting the selection cable penetrating portion and a second end of the assembling slit portion abutting the upper surface of the body portion.

Meanwhile, the body portion may have a shape with a rounded quadrangular cross section having both semi-circular sides, the shift cable penetrating portion may be disposed at a central portion of the semi-circular portion at one side of the body portion, and the selection cable penetrating portion may be disposed at a central portion of the semi-circular portion at the other side of the body portion. In addition, a distance D between the shift cable penetrating portion and the selection cable penetrating portion may be greater than the sum of a radius R1 of the semi-circular portion in which the shift cable penetrating portion is disposed and a radius R2 of the semi-circular portion in which the selection cable penetrating portion is disposed.

In addition, a width W of the body portion may be greater than an average of the radius R1 of the semi-circular portion in which the shift cable penetrating portion is disposed and the radius R2 of the semi-circular portion in which the selection cable penetrating portion is disposed, and less than the distance D between the shift cable penetrating portion and the selection cable penetrating portion. In addition, a width B of the assembling slit portion may be less than about a quarter of an inner diameter C of the selection cable penetrating portion.

Another exemplary embodiment of the present invention provides a structure for fastening the cable sponge damper for a manual transmission, in which a shift cable may be inserted and coupled through any one of the front end portion and the rear end portion of the shift cable penetrating portion, and the shift cable and the shift cable penetrating portion may be coupled to each other to be movable relative to each other. Furthermore, a selection cable may be inserted into and coupled to the selection cable penetrating portion in a lateral direction through the assembling slit portion, and the selection cable and the selection cable penetrating portion may be bonded and coupled by an adhesive to be fixed.

The present invention provides the following characteristic advantages with the aforementioned configurations.

1) The number of constituent elements of the sponge damper may be reduced from a pair of constituent elements in the related art to one constituent element, and a space between the shift cable and the selection cable may be maintained by elasticity of a damping and absorbing portion to absorb NVH, thereby improving NVH attenuation performance.

2) Furthermore, since it may be possible to provide improved NVH attenuation performance by using the sponge damper provided as a single constituent element having a width significantly less than a width of the sponge damper in the related art, it may be possible to reduce manufacturing costs and a weight in comparison with the sponge damper in the related art, and since an overall volume may be reduced in comparison with the related art, the present invention is advantageous in terms of ensuring a layout.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a manual transmission system to which a sponge damper in the related art is applied;

FIG. 2 is a top plan view illustrating the manual transmission system to which the sponge damper in the related art is applied;

FIG. 3 is a side view illustrating the manual transmission system to which the sponge damper in the related art is applied;

FIG. 4 illustrates a cross section of a portion of the sponge damper in the related art;

FIG. 5 is a perspective view illustrating a cable sponge damper for a manual transmission according to an exemplary embodiment of the present invention and a structure for fastening the cable sponge damper;

FIG. 6 is a front view of FIG. 5 according to an exemplary embodiment of the present invention;

FIGS. 7A to 7C are a perspective view, a top plan view, and a side view illustrating a manual transmission to which the cable sponge damper for a manual transmission according to the exemplary embodiment of the present invention and a structure for fastening the cable sponge damper are applied;

FIG. 8 is a cross-sectional view illustrating a configuration in which a cross section illustrated in FIG. 6 is divided into predetermined sections for convenience of description of constituent elements according to an exemplary embodiment of the present invention; and

FIGS. 9A-9B are views illustrating a schematic comparison between the configuration of the sponge damper in the related art and the configuration of the sponge damper according to an exemplary embodiment of the present invention.

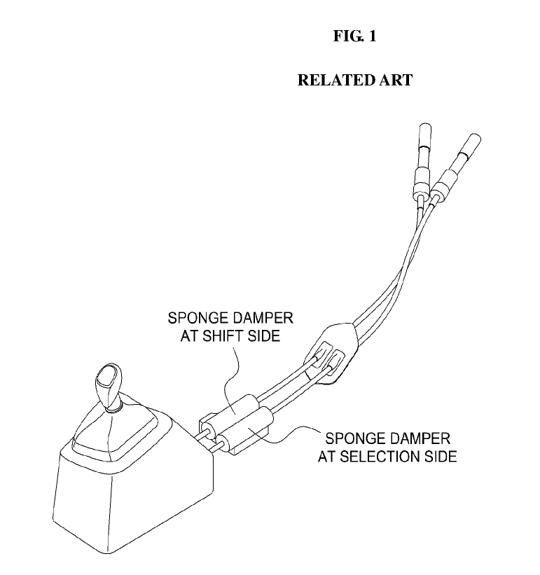

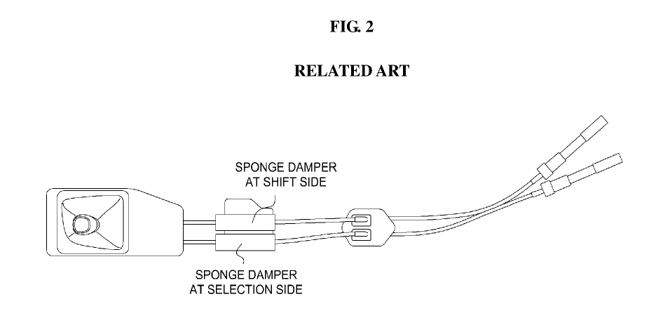

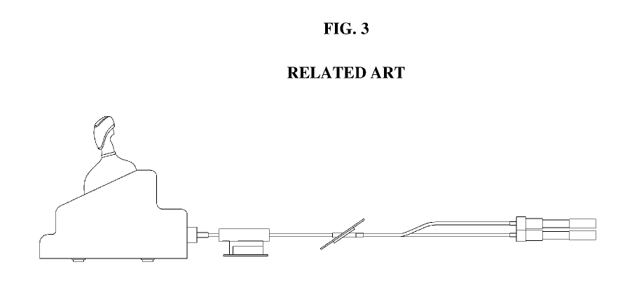

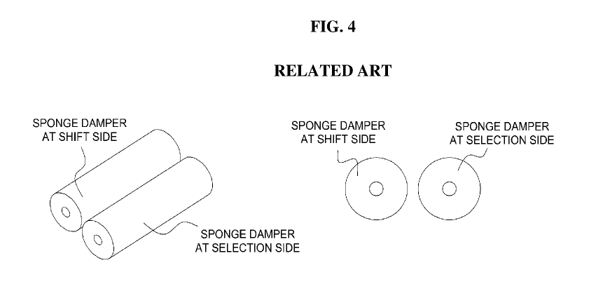

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention is provided to solve problems such as a limitation of a layout, high manufacturing costs, deterioration in NVH attenuation performance, and deterioration in operating characteristics caused by a configuration in which cable sponge dampers for a manual transmission in the related art are provided as separate constituent elements at a shift cable side and a selection cable side of a manual transmission, and a pair of sponge pads as separated constituent elements is coupled thereto, respectively, and the present invention provides a cable sponge damper for a manual transmission as a single constituent element, and improves NVH attenuation performance by using a sponge damper having a smaller volume compared to the related art.

Hereinafter, in the following specific description of technical configurations of the present invention, terms or words used in the specification and the claims should not be interpreted as being limited to a general and dictionary meaning and should be interpreted as a meaning and a concept which conform to the technical spirit of the present invention based on a principle that an inventor can appropriately define a concept of a term in order to describe his/her own invention by the best method. Therefore, the exemplary embodiments disclosed in the present specification and the technical configurations illustrated in the drawings are just the best preferred exemplary embodiments of the present invention and do not fully represent the technical spirit of the present invention. Accordingly, it should be appreciated that various equivalents and modified examples capable of substituting them may be made at the time of filing the present application. In addition, terms used in the present specification are used to more easily describe specific exemplary embodiments, and are not intended to limit the present invention. In addition, it should be understood that singular expressions used herein include plural expressions thereof unless the context clearly dictates otherwise.

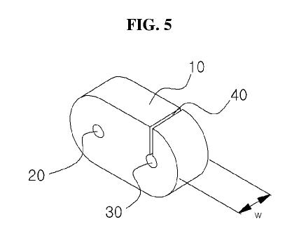

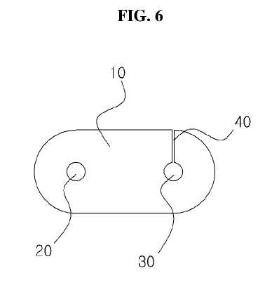

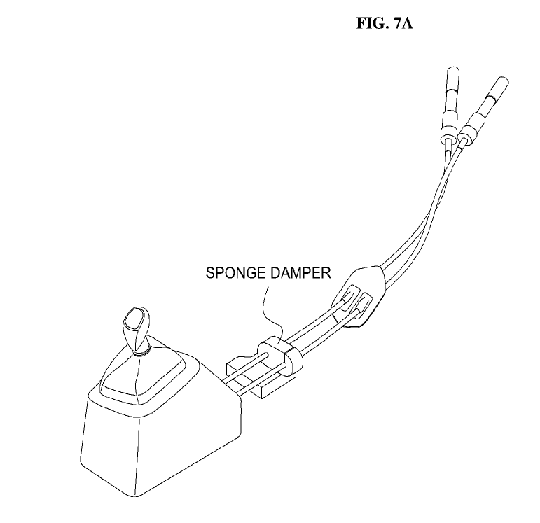

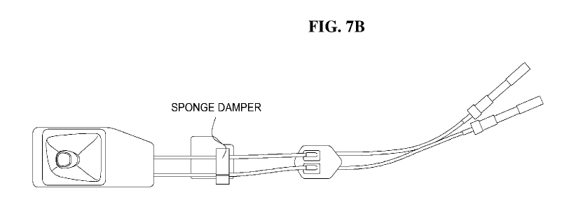

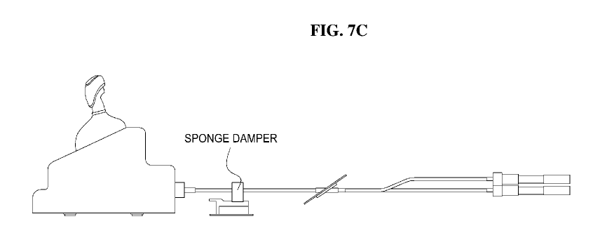

FIG. 5 is a perspective view illustrating a cable sponge damper for a manual transmission according to an exemplary embodiment of the present invention and a structure for fastening the cable sponge damper, and FIG. 6 illustrates a front view of FIG. 5. FIGS. 7A to 7C are a perspective view, a top plan view, and a side view illustrating a manual transmission to which the cable sponge damper for a manual transmission according to the exemplary embodiment of the present invention and a structure for fastening the cable sponge damper are applied.

As described above, the present invention has technical characteristics in that a sponge damper is constructed as a single constituent element. As illustrated in FIGS. 5 and 6, a sponge damper according to an exemplary embodiment of the present invention may include a body portion 10 having a sponge material and a predetermined shape, and a shift cable penetrating portion 20 and a selection cable penetrating portion 30 formed to in parallel to each other inside the body portion 10. The shift cable penetrating portion 20 and the selection cable penetrating portion 30 may be formed by piercing the body portion 10 in a horizontal direction to allow the shift cable penetrating portion 20 and the selection cable penetrating portion 30 to extend straight from a front end portion to a rear end portion of the body portion 10.

Further, a shift cable may be inserted into the shift cable penetrating portion 20, and the shift cable may be inserted into and coupled to any one of a front end portion and a rear end portion of the shift cable penetrating portion 20. In particular, in the exemplary embodiment of the present invention, the shift cable and the shift cable penetrating portion 20, coupled to each other as the shift cable penetrates the shift cable penetrating portion 20, may be coupled to each other without using a separate adhesive thus allowing the shift cable and the shift cable penetrating portion 20 to be movable relative to each other (e.g., the elements are not fixed).

In addition, a selection cable may be penetratively coupled to the selection cable penetrating portion 30, and the selection cable may be coupled in a lateral direction through an assembling slit portion 40 (will be described below) connected with the selection cable penetrating portion 30. Particularly, in the exemplary embodiment of the present invention, the selection cable and the selection cable penetrating portion 30 may be bonded together to be fixed by a separate adhesive. The shape of the body portion 10 according to the present invention is not limited to a particular shape, but as illustrated in FIGS. 5 and 6, the sponge damper may have a three-dimensional shape with a rounded quadrangular cross section having both semi-circular sides.

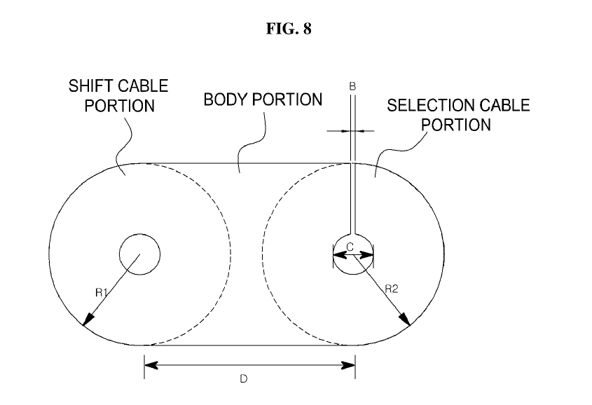

FIG. 8 is a cross-sectional view illustrating a configuration in which the cross section illustrated in FIG. 6 is divided into predetermined sections for convenience of description of constituent elements according to the present invention. FIG. 8 illustrates a shift cable portion, a selection cable portion, and a body portion.

The shift cable portion and the selection cable portion may have a pair of circular shapes having the same diameter, and the shift cable penetrating portion 20 and the selection cable penetrating portion 30, formed to have a predetermined diameter by piercing the shift cable portion and the selection cable portion, may be disposed at substantially central portions of the shift cable portion and the selection cable portion, respectively. In particular, as illustrated in FIGS. 6 and 8, the assembling slit portion 40 may be formed by piercing the selection cable portion to extend upward from the central portion of the selection cable penetrating portion 30. The assembling slit portion 40 is a constituent element through which the selection cable may be inserted at the lateral direction of the sponge damper when the selection cable is coupled to the sponge damper.

Furthermore, the assembling slit portion 40 may extend from the front end portion to the rear end portion along a central axis of the selection cable penetrating portion 30, and may be formed by being cut out (e.g., removed from) vertically with a first end of the assembling slit portion 40 abutting the selection cable penetrating portion 30 and a second end of the assembling slit portion 40 abutting an outer surface of the body portion 10. The second end of the assembling slit portion 40 may be formed by being cut out (e.g., removed) vertically to abut an upper surface of the body portion 10.

With the aforementioned configuration, the sponge damper according to an exemplary embodiment of the present invention may be formed to have a three-dimensional shape with a predetermined width and the cross section illustrated in FIGS. 6 and 8. Meanwhile, in the exemplary embodiment of the present invention, a distance D between the shift cable penetrating portion 20 and the selection cable penetrating portion 30 may be greater than the sum of radii R1 and R2 of the shift cable penetrating portion 20 and the selection cable penetrating portion 30.

When the distance between the shift cable penetrating portion 20 and the selection cable penetrating portion 30 is less than the sum of the radii of the shift cable penetrating portion 20 and the selection cable penetrating portion 30 (D<R1+R2), the NVH may not be sufficiently improvement compared to the sponge dampers in the related art which are formed as a pair of constituent elements separated from each other, and in addition, since a minimal space is present between the shift cable and the selection cable when the shift cable and the selection cable are coupled by the sponge damper according to the present invention which is formed as a single constituent element, assembly of the shift cable and the selection cable may be difficult during a manufacturing process, thus causing a disadvantage during the manufacturing process.

Consequently, the distance between the shift cable penetrating portion 20 and the selection cable penetrating portion 30 may be set to be greater than the sum of the radii of the shift cable penetrating portion 20 and the selection cable penetrating portion 30 (D>R1+R2). In addition, in the exemplary embodiment of the present invention, a width (indicated by W in FIG. 5) of the sponge damper may be set to be greater than an average of the radii of the shift cable portion and the selection cable portion, and may be less than the distance between the shift cable penetrating portion 20 and the selection cable penetrating portion 30. In other words, a width W of the sponge damper may be greater than the average of the radii of the shift cable portion and the selection cable portion (R1+R2/2), and may be less than the distance D between the shift cable penetrating portion 20 and the selection cable penetrating portion 30.

Furthermore, it may be difficult to obtain a sufficient effect in proportion to an increase in manufacturing costs even though the width W of the sponge damper becomes excessively large, and when the width W of the sponge damper is insufficient, a damping effect applied on the shift cable and the selection cable may be consequently reduced. Thus, the width W of the sponge damper may be set to be greater than the average of the radii of the shift cable portion and the selection cable portion (R1+R2/2), and less than the distance D between the shift cable penetrating portion 20 and the selection cable penetrating portion 30 ((R1+R2/2)<W<D).

In addition, in the exemplary embodiment of the present invention, an inner gap B in the assembling slit portion 40 may be set to be less than an inner diameter C of the selection cable penetrating portion 30, and more particularly, the inner gap B in the assembling slit portion 40 may be set to be less than about a quarter of the inner diameter C of the selection cable penetrating portion 30.

When the inner gap B in the assembling slit portion 40 is insufficient (e.g., too small), assembly of the selection cable may be difficult since it may be difficult to pass the selection cable through the assembling slit portion 40. Conversely, when the inner gap B in the assembling slit portion 40 is excessive, there is concern that even though a bonding coupling is performed after the assembly, the selection cable may be withdrawn when the selection cable is assembled under an adverse condition, or withdrawn while the vehicle is driven after the assembly. Therefore, as described above, the inner gap B in the assembling slit portion 40 may be less than about a quarter of the inner diameter C of the selection cable penetrating portion 30.

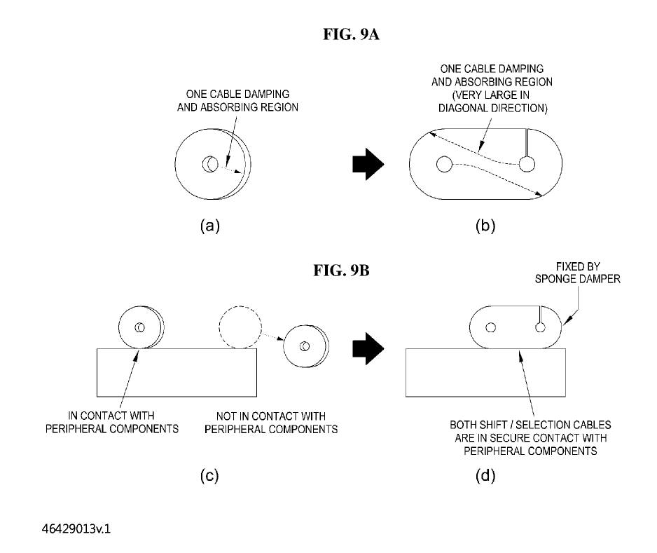

FIGS. 9A and 9B are views illustrating a schematic comparison between the configuration of the sponge damper in the related art and the configuration of the sponge damper according to an exemplary embodiment of the present invention, and as illustrated in (a) of FIG. 9A, the sponge damper in the related art is applied to only a single cable and configured to serve to attenuate the NVH transmitted through the single cable, and portion (a) of FIG. 9A shows that a damping and absorbing region is relatively minimal. In contrast, as illustrated in (b) of FIG. 9A, in the present invention, one sponge damper may be applied to both cables and may decrease the NVH, and a section for performing a damping action is increased in proportion to a distance between the two cables, and as a result, portion (b) of FIG. 9A shows a damping and absorbing region applied to each of the cables may be much greater than that of the sponge damper in the related art.

In addition, as illustrated in (c) of FIG. 9B, the sponge dampers in the related art are configured as the pair of constituent elements applied to the two cables, and the pair of sponge dampers is separately applied, and as a result, portion (c) of FIG. 9B shows that the pair of sponge dampers may be spaced apart from each other and a space between the pair of sponge dampers may be increased due to vibration occurring when the vehicle is driven. The sponge dampers are configured to be in contact with peripheral components to attenuate the NVH transmitted through the cables, and as a result, when at least one of the pair of sponge dampers is withdrawn from its own position and is not in contact with the peripheral components, an effect of attenuating the NVH may be decreased.

In contrast, as illustrated in (d) of FIG. 9B, in the present invention, one sponge damper may be coupled to both cables, and as a result, the cables may be fixed thus preventing the sponge damper from being separated from peripheral components. Therefore, the sponge damper according to the present invention, which is configured as described above, has substantially improved NVH attenuation performance compared to the sponge damper in the related art.

While the exemplary embodiments of the cable sponge damper for a manual transmission according to the present invention and the structure for fastening the cable sponge damper have been described above, the exemplary embodiments of the present invention merely suggest specific examples for better understanding of the present invention, but are not intended to limit the scope of the present invention. It is obvious to those skilled in the technical field to which the present invention pertains that in addition to the exemplary embodiments disclosed herein, various modifications may be implemented based on the technical spirit of the present invention.

What is claimed is:

1. A cable sponge damper for a manual transmission, comprising:
a body portion including a sponge material of a predetermined shape;
a shift cable penetrating portion formed by piercing the body portion to extend straight from a front end portion to a rear end portion of the body portion;
a selection cable penetrating portion formed by piercing the body portion to extend straight from the front end portion to the rear end portion of the body portion, and disposed in parallel with the shift cable penetrating portion; and
an assembling slit portion that extends from the front end portion to the rear end portion along a central axis of the selection cable penetrating portion, and is formed by being cut out with a first end of the assembling slit portion abutting the selection cable penetrating portion and a second end of the assembling slit portion abutting an outer surface of the body portion.

2. The cable sponge damper of claim 1, wherein the assembling slit portion extends from the front end portion and the rear end portion along the central axis of the selection cable penetrating portion and is formed by being cut out vertically with the first end of the assembling slit portion abutting the selection cable penetrating portion and the second end of the assembling slit portion abutting the outer surface of the body portion.

3. The cable sponge damper of claim 1, wherein the body portion has a three-dimensional shape with a rounded quadrangular cross section having both semi-circular sides, the shift cable penetrating portion is disposed at a central portion of the semi-circular portion at a first side of the body portion, and the selection cable penetrating portion is disposed at a central portion of the semi-circular portion at a second side of the body portion.

4. The cable sponge damper of claim 3, wherein a distance between the shift cable penetrating portion and the selection cable penetrating portion is greater than the sum of a radius of the semi-circular portion in which the shift cable penetrating portion is disposed and a radius of the semi-circular portion in which the selection cable penetrating portion is disposed.

5. The cable sponge damper of claim 3, wherein a width of the body portion is greater than an average of the radius of the semi-circular portion in which the shift cable penetrating portion is disposed and the radius of the semi-circular portion in which the selection cable penetrating portion is disposed, and less than the distance between the shift cable penetrating portion and the selection cable penetrating portion.

6. The cable sponge damper of claim 3, wherein an inner gap in the assembling slit portion is less than about a quarter of an inner diameter C of the selection cable penetrating portion.

7. A structure for fastening the cable sponge damper for a manual transmission of claim 1, wherein a shift cable is inserted and coupled through any one of the front end portion and the rear end portion of the shift cable penetrating portion, and the shift cable and the shift cable penetrating portion are coupled to each other to be movable relative to each other.

8. A structure for fastening the cable sponge damper for a manual transmission of claim 1, wherein a selection cable is inserted into and coupled to the selection cable penetrating portion in a lateral direction through the assembling slit portion, and the selection cable and the selection cable penetrating portion are bonded and coupled by an adhesive to be fixed.
